(19) United States
(12) Patent Application Publication
(10) Pub. No.: US 2022/0383327 A1
(43) Pub. Date: Dec. 1, 2022

(54) Method and device for transmitting an identifier of a user during an electronic payment made by the user.

(71) Applicant: Orange, Issy-Les-Moulineaux (FR)

(72) Inventors: Emmanuel Le Huerou, Chatillon Cedex (FR); François Toutain, Chatillon Cedex (FR); Michael Pontiggia, Chatillon Cedex (FR)

(21) Appl. No.: 17/828,569

(22) Filed: May 31, 2022

(30) Foreign Application Priority Data
Jun. 1, 2021 (FR) 2105770

(51) Int. Cl. G06Q 20/40; G06Q 20/20

(52) U.S. Cl. CPC G06Q 20/40145; G06Q 20/202

(57) ABSTRACT

A method for transmitting, during an electronic payment made by at least one user, at least one second identifier of the at least one user. The method is implemented by a transmitting device and includes: obtaining at least one first identifier of the at least one user from at least one electronic payment element of the at least one user, the at least one first identifier being used for the electronic payment; generating the at least one second identifier of the user, the second identifier comprising at least one datum and one portion of the at least one first identifier; and when the electronic payment has completed, transmitting the at least one second identifier to a device for managing at least one electronic proof of purchase.

### FIELD OF THE INVENTION

The invention belongs to the field of telecommunications and in particular relates to a system for transmitting a proof of purchase.

### PRIOR ART

Any expenditure resulting in payment to a trader is accompanied by a proof of purchase, such as for example a sales slip, an invoice, a guarantee or any other form of receipt. Soon to be banned by law in France for small amounts, the elimination of paper receipts has encouraged the adoption of digital receipts.

Various receipt-digitization solutions based on digital communication technologies are already available. For example, an increasing number of merchants offer their customers electronic receipts that may be accessed via the account of the customer or sent by email after checkout. Such systems are often associated with a loyalty card allowing the customer to be rapidly identified with a view to transmitting the proof of purchase thereto. Concretely, once the loyalty card of the customer has been scanned by the till system then the payment made, the receipt associated with the transaction is transmitted by the till system to a server. The receipt is then received by the server, which processes it (adds points to an account, creates discount vouchers, etc.) then sends it to the customer. When the customer is not known to the trader (if he does not have a loyalty card), the trader has no other choice than to ask the customer for his details (email address, social network identifier, etc.).

In order to avoid this operation, which is not very ergonomic and quite time-consuming, it would be advantageous to use the data of the bank transaction, in particular in the case of payment by bank card, and thus automate the dispatch of the electronic receipt to the customer. Specifically, each bank card comprises at least one PAN (for Primary Account Number) of 16 or 19 digits that allows the customer to be identified via the bank account with which the bank card is associated. This PAN is read by the electronic payment terminal (EPT) during the transaction (i.e. the payment). However, security rules in force forbid this number from being transmitted out of the EPT (except to a bank server), and in particular to the till of the merchant when the EPT and the till are connected to each other. At best, a partial number or a token may be transmitted.

### SUMMARY OF THE INVENTION

The invention aims to improve the prior art and provides, to this end, a method for transmitting, during an electronic payment made by at least one user, at least one second identifier of said at least one user, said method being implemented by a transmitting device and being characterized in that it comprises:
a step of obtaining at least one first identifier of said at least one user from at least one electronic payment means of said at least one user, said at least one first identifier being used for said electronic payment;
a step of generating said at least one second identifier of said user, said second identifier comprising at least one datum and one portion of said at least one first identifier;

and when said electronic payment has completed
a step of transmitting said at least one second identifier to a device for managing at least one electronic proof of purchase.

Advantageously, this method allows an identifier (second identifier) of a user to be delivered to a device for managing proofs of purchase, such as an application server or a till system of a merchant, when the user completes a payment.

Concretely, when a user makes a payment to a trader, the transmitting method retrieves a user identifier used for the payment, such as for example the PAN of the bank card. The method then generates a new identifier from the obtained identifier. The generated identifier comprises at least one datum allowing the user to be identified and one portion of the obtained identifier.

When the obtained identifier is the PAN of a bank card, the portion of the identifier may correspond to the first eight digits of the PAN, which identify the bank that issued the bank card. Once the payment has completed, the method transmits the generated identifier to a device for managing electronic proofs of purchase.

Thus, the initial user identifier (obtained identifier) that allowed the payment is not disclosed to the device for managing electronic proofs of purchase and security rules are thus respected. It will be recalled that, when it is a question of the PAN of a bank card, security rules in force forbid it to be transmitted by the EPT to non-bank equipment.

By identifier used for an electronic payment, what is meant is an identifier that allows the payment to be made (i.e. that is involved in the payment). Concretely, without the identifier, the payment cannot be made.

By identifier, what is meant is a sequence of characters that serves to identify a user during a payment. The identifier may be a bank-card number (PAN), an account number, an instant-messaging address, a telephone number, etc.

By proof of purchase, what is meant is any document relating to a transaction, such as for example a sales slip, a guarantee certificate, a discount voucher or any other receipt.

By electronic payment means, what is meant is any means of payment that makes it possible to perform a financial transaction between a plurality of parties, such as a bank card, a barcode, a virtual-bank-card number, a SIM card, an account number, an instant-messaging address, etc.

By digital fingerprint, what is meant is the result of application of a cryptographic function such as a hash function.

According to one particular mode of implementation of the invention, a method such as described above is characterized in that said at least one datum comprises at least one digital fingerprint of said at least one first identifier.

This mode of implementation of the invention allows, for example, the generated identifier to comprise a digital fingerprint generated via application of a cryptographic function to the obtained identifier, the digital fingerprint allowing the user to be identified.

It will be noted that the digital fingerprint (digital signature) may be generated using all or some of the obtained identifier.

According to one particular mode of implementation of the invention, a method such as described above is characterized in that said at least one datum comprises a third identifier obtained from a bank server.

This mode of implementation of the invention allows, for example, the generated identified to comprise an ephemeral user identifier (single-use identifier) obtained from a bank server. This mode of implementation requires the transmitting device, an EPT for example, to be connected to a remote bank server. This connection is for example required when the payment requires prior bank authorization or when a security procedure such as 3DSecure (request for a complimentary authentication of the user) is employed.

According to one particular mode of implementation of the invention, a method such as described above is characterized in that said at least one datum comprises a third identifier obtained from a bank server and a digital fingerprint of said at least one first identifier.

This mode of implementation of the invention allows security to be increased. Specifically, the generated identifier comprises two different user identifiers and thus allows a double verification of the user.

The invention also relates to a method for managing at least one electronic proof of purchase, said method being implemented by a managing device and being characterized in that it comprises:
a first step of receiving, from a till device, at least one identifier of at least one user and at least one proof of purchase, said at least one proof of purchase and said at least one identifier being sent subsequent to an electronic payment made by said at least one user;
a step of obtaining at least one electronic address of said at least one user, said address being obtained using said at least one received identifier;
a first step of sending said at least one proof of purchase to said at least one obtained electronic address.

This embodiment allows a proof of purchase to be sent to a user who has completed an electronic payment to a trader, for example in the particular case where the managing method is executed by a managing device operated by the bank of the user. Concretely, when a user completes a payment, for example by means of a bank card, the managing method receives from a processing device, via for example a till device of the trader, a user identifier. This identifier comprises a digital fingerprint generated by applying a cryptographic function to the PAN. The managing method also receives, from the till device, a proof of purchase related to the payment made by the user.

The method then, for example from a digital storage space such as a database or a file, obtains an electronic address of the user in response to a request comprising the digital fingerprint in its parameters. Of course, the bank of the user knows the PAN of the user and the cryptographic function that allowed the digital fingerprint to be generated in the processing device. Therefore, said bank is able to generate the same digital fingerprint and to fill beforehand the digital storage space with the pair consisting of the electronic address of the user and of the digital fingerprint of the PAN of the user. It will be noted that the electronic address is for example sourced from the customer portal of the bank of the user. Once the electronic address of the user has been obtained, the method sends to the user a proof of purchase related to the payment made.

According to one particular mode of implementation of the invention, a method such as described above is characterized in that the obtaining step comprises a second step of sending a request to at least one recipient determined depending on said at least one received identifier, said request comprising at least said received identifier, and a step of receiving, in response to said request, at least one electronic address.

This embodiment allows, in the particular case where the managing method is executed by a third party independent of the bank of the user, a proof of purchase to be sent to the user. To do this, the method determines the bank that issued the means of payment by virtue of the received identifier, which for example comprises a succession of eight numbers corresponding to the first eight digits of the PAN of the bank card used by the user for the payment. Specifically, the first eight digits of the PAN of the bank card allow the organization that issued the bank card, i.e. the bank of the user, to be identified. Once the bank is known, the method obtains, for example from a digital storage space, an electronic address (URL, email address, etc.) of the bank then sends it to the received identifier. The bank, by virtue of the received identifier, which comprises a digital fingerprint of the PAN of the bank card used by the user during the payment, obtains an electronic address of the user. This electronic address is for example obtained from a digital storage space such as a database or a file. In response to the request, the bank transmits the obtained electronic address of the user, if of course the user has permitted this to be done. The method then sends, to the electronic address of the user, a proof of purchase related to the payment made by the user.

By electronic address, what is meant is a string of characters that makes it possible to identify an electronic mailbox or a social-network account allowing the holder of the account or of the digital mailbox to receive messages (emails, instant messages according for example to the RCS standard (RCS standing for Rich Communication Suite) or the SMS standard (SMS standing for Short Message Service), or any other text, audio or video message).

The invention also relates to a transmitting device, characterized in that it comprises:
a module for obtaining at least one first identifier of said at least one user from at least one electronic payment means of said at least one user, said at least one first identifier being used for said electronic payment;
a module for generating said at least one second identifier of said user, said second identifier comprising at least one digital fingerprint of said at least one first identifier and one portion of said at least one first identifier;
a module for transmitting said at least one second identifier to a device for managing at least one electronic proof of purchase.

The invention also relates to a managing device, characterized in that it comprises:
a module for receiving, from a till device, at least one identifier of at least one user and at least one proof of purchase, said at least one proof of purchase and said at least one identifier being sent subsequent to an electronic payment made by said at least one user;
a module for obtaining at least one electronic address of said at least one user, said address being obtained using said at least one received identifier;
a module for sending said at least one proof of purchase to said at least one obtained electronic address.

The term module may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly able to implement a function or a set of functions for the module in question (integrated circuit, chip card, memory card, etc.).

The invention also relates to an electronic payment terminal, characterized in that it comprises a transmitting device.

The invention also relates to a computer program comprising instructions for implementing the above methods according to any one of the particular embodiments described above when said program is executed by a processor. The methods may be implemented in various ways, in particular in hard-wired form or in the form of software. This program may use any programming language and be in the form of source code, object code or intermediate code between source code and object code, such as in a partially compiled form, or in any other desirable form.

The invention also targets a computer-readable recording medium or information medium containing instructions of a computer program such as mentioned above. The abovementioned recording media may be any entity or device capable of storing the program. For example, the medium may comprise a storage means, such as a ROM, for example a CD-ROM or a microelectronic circuit ROM, or else a magnetic recording means, for example a hard disk. Moreover, the recording media may correspond to a transmissible medium such as an electrical or optical signal, which may be routed via an electrical or optical cable, by radio or by other means. The programs according to the invention may in particular be downloaded from an Internet network.

As an alternative, the recording media may correspond to an integrated circuit in which the program is incorporated, the circuit being designed to execute or to be used in the execution of the method in question. These transmitting and managing devices and this computer program have features and advantages that are analogous to those described above with reference to the transmitting and managing method.

### LIST OF THE FIGURES

Other features and advantages of the invention will become more clearly apparent upon reading the following description of particular embodiments, provided by way of simple illustrative and non-limiting examples, and the appended drawings, in which:

FIG. 1 illustrates an example of an environment of implementation according to one particular embodiment of the invention;

FIG. 2 illustrates the hardware architecture of a device configured to implement the transmitting method according to one particular embodiment of the invention;

FIG. 3 illustrates the hardware architecture of a device configured to implement the managing method according to one particular embodiment of the invention;

FIG. 4 illustrates steps of the transmitting and managing methods according to one particular embodiment of the invention.

### DESCRIPTION OF ONE EMBODIMENT OF THE INVENTION

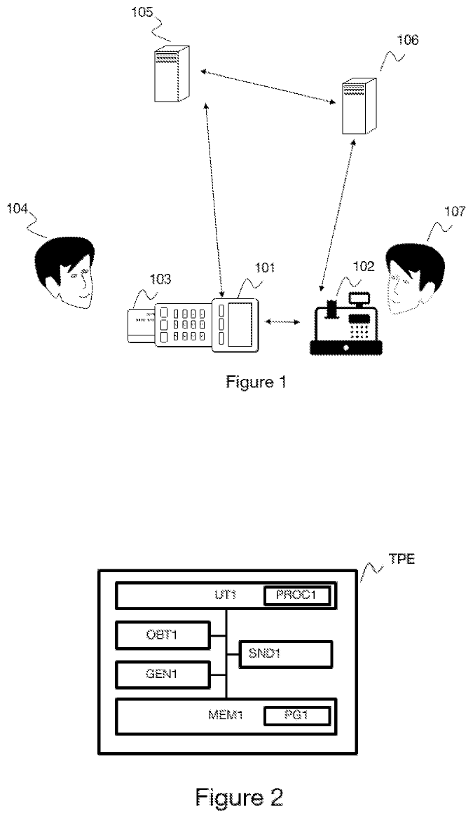

FIG. 1 illustrates an example of an environment of implementation of the invention according to one particular embodiment of the invention. The environment shown in FIG. 1 comprises an electronic payment terminal 101 (EPT) that executes the transmitting method, a till device 102, a bank server 105 and an application server 106 that executes the managing method. FIG. 1 also shows an electronic payment means 103 belonging to a user 104. The payment means shown here is a bank card but the invention is applicable to any electronic payment means (virtual-bank-card number, mobile terminal comprising a secure element, barcode, instant-messaging address, etc.).

The payment terminal 101 and the bank server 105, the payment terminal 101 and the till device 102, the till device 102 and the application server 106, and the application server 106 and the bank server 105, may be connected to each other via one or more communication networks. The communication networks used are for example public communication networks such as the Internet, or indeed private communication networks. These communication networks may be accessible via an access network (not shown) such as a wired network, a wireless (Wi-Fi, Bluetooth, etc.) network or a 2G, 3G, 4G or 5G cellular data network.

When a bank transaction is performed between the customer 104 and the merchant 107, a customer identifier containing a portion encrypted by the electronic payment terminal is transmitted to the till device 102. This identifier and a proof of purchase generated by the till device 102 are then sent by the latter to the application server 106. Depending on the received identifier, the application server 106 obtains a digital address of the customer 103. The proof of purchase is then sent by the application server 106 to the obtained electronic address.

As known, the payment terminal 101 may, during the transaction, make an authorization request to the bank server 105 in order to obtain or not a validation of the payment.

According to one particular embodiment of the invention, the server 106 and the till device 102 may be one and the same device.

According to one particular embodiment of the invention, the payment terminal 101 may comprise the till device 102. In this particular case, the user identifier will be received by the till device 102 via messages internal to the terminal 101. The same terminal may also be contained within a computer or any other device having the architecture of a computer, such as a smartphone, a tablet, a voice assistant, etc. thus making it possible to make purchases on-line. Concretely, the user may, for example, input information present on his bank card (PAN, CVV, expiry date) into a graphical interface displayed by an Internet browser in order to make the payment.

According to one particular embodiment of the invention, the servers 105 and 106 may be one and the same server.

According to one particular embodiment of the invention, the payment may involve a plurality of payment means and a plurality of users (payment shared between a number of people).

According to one particular embodiment of the invention, all of the messages exchanged between the payment terminal 101 and the bank server 105, the payment terminal 101 and the till device 102, the till device 102 and the application server 106, and between the application server 106 and the bank server 105, may be messages that are encrypted/ciphered for example via private/public key encryption mechanisms.

According to one particular embodiment of the invention, the environment may comprise a plurality of EPTs 101 connected to the till device 102.

According to one particular embodiment of the invention, the environment may comprise a plurality of EPTs 101 connected to the bank server 105.

According to one particular embodiment of the invention, the environment may comprise a plurality of till devices 102 connected to the application server 106.

According to one particular embodiment of the invention, the environment may comprise a plurality of bank servers 105 connected to the application server 106.

According to one particular embodiment of the invention, the environment may comprise a plurality of application servers 106 connected to the bank server 105.

FIG. 2 illustrates a device TPE that implements the invention according to one particular embodiment. The device TPE has the conventional architecture of a computer, and comprises in particular a memory MEM1, and a processing unit UT1 that is equipped for example with a processor PROC1, and that is driven by the computer program PG1 stored in the memory MEM1. The computer program PG1 comprises instructions for implementing the steps of the transmitting method such as described below with reference to FIG. 4, when the program is executed by the processor PROC1.

On initialization, the code instructions of the computer program PG1 are for example loaded into a memory, before being executed by the processor PROC1. The processor PROC1 of the processing unit UT1 in particular implements the steps of the enrichment method according to any one of the particular embodiments described with reference to FIGS. 1 and 4 according to the instructions of the computer program PG1.

The device TPE also comprises an obtaining module OBT1 able to obtain an identifier of a user who has completed a payment to a trader. This identifier is for example obtained from the electronic payment means used by the user during the payment. The device TPE further comprises a generating module GEN1 able to generate a new user identifier depending on the identifier obtained via the module OBT1. This module may for example carry out:
operations to encrypt all or some of the obtained identifier (digital fingerprint);
operations to assemble/concatenate portions (whether encrypted or not) of the obtained identifier;
operations to add strings of characters to the obtained identifier, i.e. strings such as a prefix, a suffix or a new identifier;
operations to delete a portion of the identifier;
or any other operation to manipulate the string of characters representing the obtained identifier.

The device TPE in addition comprises a transmitting/sending module SND1 able to send messages via for example an IP network. The sending module SND1 is for example used to send to a managing device the identifier generated by the module GEN1.

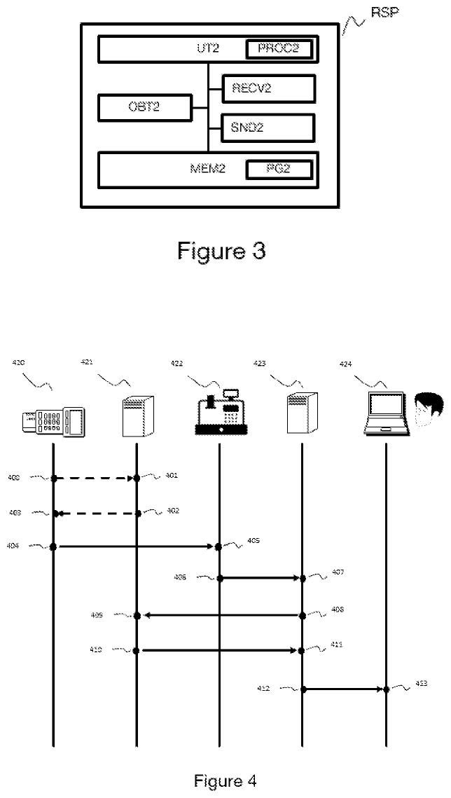

FIG. 3 illustrates a device RSP that implements the invention according to one particular embodiment. The device RSP has the conventional architecture of a computer, and comprises in particular a memory MEM2, and a processing unit UT2 that is equipped for example with a processor PROC2, and that is driven by the computer program PG2 stored in the memory MEM2. The computer program PG2 comprises instructions for implementing the steps of the transmitting method such as described below with reference to FIG. 4, when the program is executed by the processor PROC2.

On initialization, the code instructions of the computer program PG2 are for example loaded into a memory, before being executed by the processor PROC2. The processor PROC2 of the processing unit UT2 in particular implements the steps of the managing method according to any one of the particular embodiments described with reference to FIGS. 1 and 4 according to the instructions of the computer program PG2.

The device RSP also comprises a communication module RECV2 configured to receive, for example via an IP network, an identifier of a user from a till device when the user has completed a payment to a trader.

The device RSP further comprises an obtaining module OBT2 able to obtain, depending on the identifier received by the module RECV2, an electronic address of the user. In addition, the device RSP comprises a module SND2 able to send a message comprising a proof of purchase to the electronic address obtained by the module OBT2.

According to one particular embodiment the invention, the modules RECV2 and SND2 are one and the same communication module.

According to one particular embodiment of the invention, the module RECV2 is also able to receive a message comprising an electronic address of the user in response to a request sent by the module SND2 to for example a bank server and comprising the identifier received by the module RECV2.

FIG. 4 illustrates steps of the transmitting and managing methods according to one particular embodiment of the invention, and illustrates the particular case of an electronic transaction in the context of the environment of FIG. 1.

In step 404 a user (i.e. a customer) uses an electronic payment means to make a purchase from a trader. To do this, he inserts a bank card into an electronic payment terminal (EPT) 420 (101 in FIG. 1) and enters his personal identification number to validate the transaction. If the code entered is valid, then the EPT generates a user identifier on the basis of an identifier obtained from the bank card. The obtained identifier is for example the PAN of the bank card.

Concretely, during the payment, the EPT retrieves the complete PAN of the bank card of the user, which consists of an IIN (Issuer Identification Number) that corresponds to the digits allowing the bank that issued the bank card to be identified, and of a number identifying the user. The EPT then generates a digital fingerprint HPAN using all or some of the PAN, by virtue of a cryptographic function with which it is provided.

The EPT then transmits an identifier that comprises the IIN and the HPAN to the till system 422. It will be noted that generating an identifier on the basis of the PAN allows the security rules in force, which forbid the transmission of the PAN outside of the EPT (in particular, when the EPT is connected to a till system), to be respected.

Alternatively, the method separately transmits, in the same message or in different messages, the IIN and the HPAN to the till system 422.

The till system 422 receives the identifier in step 405 and generates the electronic receipt.

The till system 422 then transfers (step 406) the electronic receipt and the received identifier to the application server 423.

In step 407, the application server 423 is able to determine which bank issued the bank card of the user, especially by virtue of the received identifier and more precisely of the IIN.

Once the bank that issued the bank card has been determined, the application server 423 sends a request (step 408) comprising the HPAN to a server 421 of the bank. In step 410, the bank server 421 transmits, to the application server 423, in response to the received request (step 409), an electronic address of the user. Specifically, the bank hosts internally a lookup table that allows it to find an electronic address of the customer depending on information such as the HPAN. Of course, this table was constructed using the same cryptographic function that was in applied by the EPT to generate the HPAN. In step 411, the application server 423 receives the electronic address of the user from the bank server 421 then sends the electronic receipt received in step 407 to the electronic address of the user (step 412).

According to one particular embodiment of the invention, whether or not the bank server 421 transmits the electronic address of the user may be dependent on rights attributed to the application server 423.

According to one particular embodiment of the invention, whether or not the bank server 421 transmits the electronic address of the user may be dependent on validation by the customer. This validation may be made permanent, for example by setting a parameter of the user account of the customer to a particular value, or given on request (on each transaction).

According to one particular embodiment of the invention, the servers 421 and 422 are one and the same server.

According to one particular embodiment of the invention, the EPT may communicate with the bank of the customer before the completion of the payment. This communication (steps 400 to 403), which is for example required for a payment via a bank card requiring a systematic bank authorization, may allow the EPT to obtain, from the bank server 421, a single-use temporary user identifier (Hid).

Alternatively, the bank server that delivers the single-use temporary user identifier to the EPT may be a second bank server, other than the bank server 421.

The EPT then transmits the IIN and the Hid to the till system in step 404. The till system then generates (step 406) the electronic receipt, which it transfers with the IIN and the Hid to the application server 423. In step 407, the application server 423 is able to determine which bank issued the bank card of the user, especially by virtue of the IIN. Once the bank that issued the bank card has been determined, the application server 423 sends a request (step 408) comprising the Hid to the bank server 421 of the bank of the user.

The bank may first verify that the application server 423 is indeed permitted to make such a request then transmit, to the application server 423 (step 410), in response to the request, an electronic address of the user. Specifically, the bank hosts internally a lookup table that allows it to find an electronic address of a customer depending on the Hid. In step 411, the application server 423 receives the electronic address of the user from the bank server 421 then sends the electronic receipt received in step 407 to the electronic address of the user (step 412).

According to one particular embodiment of the invention, the electronic receipt generated by the till system may be complemented or replaced by a content (an email, a URL/URI, etc.) allowing information such as a way of accessing a digital service provided by the trader (promotions, offers, etc.) to be delivered.

According to one particular embodiment of the invention, the payment means of the user may correspond to a string of characters, i.e. a string such as a number, a reference/a code or an email address, comprising at least one identifier of the bank of the user and one user identifier. It will be noted that the string of characters may be encoded into the form of a barcode.

According to one particular embodiment of the invention, the payment means of the user may correspond to the user identifier obtained in step 404. For example, if the user makes the payment by entering into the EPT an electronic address delivered by its bank, for example in the format: “userid@bank.com”, the EPT then generates a digital fingerprint Hid using the local portion of the electronic address (the “userid”). The EPT then transmits, to the till system 422, the domain name “bank.com” and the digital fingerprint Hid (step 404). The till system generates (step 406) the electronic receipt, which it transfers with the digital fingerprint Hid and the domain name to the application server 423. In step 407, the application server 423 is able to determine which bank is the bank of the user, especially by virtue of the domain name. Steps 408 to 413 then remain identical.

According to one particular embodiment of the invention, the payment means of the user may correspond to a pair of user identifiers obtained in step 404. For example an identifier of the banking establishment of the user and a digital representation of a biometric characteristic (fingerprint, voice, face, etc.) thereof may be used. It will be noted that the identifier of the banking establishment may be entered by the user into the EPT via a touch user interface or a voice user interface.

It goes without saying that the completely non-limiting embodiment that was described above was given purely by way of indication, and that many modifications may easily be made thereto by those skilled in the art without, however, departing from the scope of the invention.

1. A method for transmitting, during an electronic payment made by at least one user, a second identifier of said at least one user, said method being implemented by a transmitting device and comprising:
of obtaining at least one first identifier of said at least one user from at least one electronic payment means of said at least one user, said at least one first identifier being used for said electronic payment;
of generating said at least one second identifier of said user, said second identifier comprising at least one datum and one portion of said at least one first identifier;
and on completion of said electronic payment, transmitting said at least one second identifier to a device for managing at least one electronic proof of purchase.

2. The method according to claim 1, wherein said at least one datum comprises at least one digital fingerprint of said at least one first identifier.

3. The method according to claim 1, wherein said at least one datum comprises a third identifier obtained from a bank server.

4. The method according to claim 1, wherein said at least one datum comprises a third identifier obtained from a bank server and a digital fingerprint of said at least one first identifier.

5. A method for managing at least one electronic proof of purchase, said method being implemented by a managing device comprising:
of receiving, from a till device, at least one identifier of at least one user and the at least one proof of purchase, said at least one proof of purchase and said at least one identifier being received subsequent to an electronic payment made by said at least one user;
of obtaining at least one electronic address of said at least one user, said address being obtained using said at least one received identifier; and
a first step of sending said at least one proof of purchase to said at least one obtained electronic address.

6. The method according to claim 5, wherein the obtaining comprises a second step of sending a request to at least one recipient determined depending on said at least one received identifier, said request comprising at least said received identifier, and of receiving, in response to said request, at least one electronic address.

7. A transmitting device comprising:
a processor; and
a non-transitory computer-readable medium comprising instructions stored thereon which when executed by the processor configure the transmitting device to:
obtain at least one first identifier of said at least one user from at least one electronic payment means of said at least one user, said at least one first identifier being used for said electronic payment;
generate said at least one second identifier of said user, said second identifier comprising at least one digital fingerprint of said at least one first identifier and one portion of said at least one first identifier; and
transmit said at least one second identifier to a device for managing at least one electronic proof of purchase.

8. A managing device comprising:
a processor; and
a non-transitory computer-readable medium comprising instructions stored thereon which when executed by the processor configure the managing device to:
receive, from a till device, at least one identifier of at least one user and at least one proof of purchase, said at least one proof of purchase and said at least one identifier being sent subsequent to an electronic payment made by said at least one user;
obtain at least one electronic address of said at least one user, said address being obtained using said at least one received identifier; and
send said at least one proof of purchase to said at least one obtained electronic address.

9. The transmitting device of claim 7, wherein the transmitting device is implemented in an electronic.

10. (canceled)
